(19) United States
(12) Patent Application Publication
(10) Pub. No.: US 2020/0016785 A1
(43) Pub. Date: Jan. 16, 2020

(54) PROCESS FOR WOOD OIL MODIFICATION OF WOOD PRODUCTS

(71) Applicant: Stora Enso OYJ, Helsinki (FI)

(72) Inventors: Reeta-Maria STÖD, Ylamylly (FI); Tommy MARKOFF, Uimaharju (FI)

(73) Assignee: Stora Enso OYJ, Helsinki (FI)

(21) Appl. No.: 16/485,630

(22) PCT Filed: Feb. 13, 2018
(86) PCT No.: PCT/IB2018/050873

§ 371 Date: Aug. 13, 2019

(30) Foreign Application Priority Data
Feb. 14, 2017 (SE) 1750133-9

(51) Int. Cl. B27K 3/08; B27K 3/02; B27K 3/34; B27K 5/00

(52) U.S. Cl. CPC B27K 3/08; B27K 3/0207; B27K 2240/90; B27K 5/0085; B27K 2240/70; B27K 3/34

(57) ABSTRACT

The present invention relates to a process for preparing a modified wood product wherein the wood is impregnated with water-based wood oils. In one embodiment, the wood is thermally modified prior to the impregnation. The present invention also relates to a modified wood product produced using said process.

### FIELD OF THE INVENTION

The present invention relates to a process for preparing a modified wood product wherein the wood is impregnated with water-based wood oils. In one embodiment, the wood is thermally modified prior to the impregnation. The present invention also relates to a modified wood product produced using said process.

### BACKGROUND

Many wood species that are untreated are very susceptible to influences caused by the external environment. Untreated wood that is exposed to moisture and/or soil for sustainable periods of time will become weakened by attacks by various types of microorganisms or insects. It is therefore of importance to treat the less durable wood in order to increase its resistance against moisture and fungal attack. In addition wood which is exposed to Ultra Violet radiation is susceptible to discoloration and deterioration.

There exist a number of different treatment methods which will increase the resistance of wood. Chemical treatments of wood in order to increase the biological durability have been used for a long time. Many different chemicals may be added. These chemicals are normally called fungicides and they will provide long-term resistance to organisms that cause deterioration of the wood. If it is applied correctly, it can extend the productive life of timber by five to ten times.

Another known method to improve the resistance of wood is to treat the wood at high temperatures to thermally modify the wood. During heat modification, certain organic compounds found in the wood will be removed and thereby decreases the possibility for fungi and rot to thrive on the wood. Thus, by heating wood to a certain temperature, it is possible to make the ligno-cellulosic fibers less appetizing to fungi and insects. Heat modification can also improve the properties of the wood with respect to moisture both liquid and humidity, i.e. lower equilibrium moisture content, less moisture deformation, and improved weather resistance. One potential downside of thermally modified wood is the reduction in strength both in bending strength and surface hardness as a result of the modification process which might reduce the useful service life of the material.

Thermally modified wood is known to weather in certain climate conditions. During weathering, the wood surface suffers from the effects of various deteriorating factors, such as solar radiation, water (air humidity, rain), heat and different types of airborne contamination. The wood gradually wears and adapts the silver grey color as a result of functioning of blue-staining fungi and the afore-mentioned factors.

Thermally modified wood is usually protected from weathering by finishing it with wood oils. Finishing is traditionally done as surface treatment by brush, either manually or with painting machines. However, very limited amount of wood oil may be applied to the wood by these conventional methods. The oil penetration in wood markedly affects the maintenance interval required by the products.

WO2007/135222 A1 is directed to impregnation of wood under pressure at elevated temperature.

U.S. Pat. No. 6,641,927 is directed to a process for impregnation, under pressure at elevated temperature.

WO00/41861 A1 is directed to impregnation at elevated temperature.

WO2010040903 is directed to the use of an emulsion that is being absorbed into wood. The emulsion contains a reaction product of a fatty acid obtained from a natural oil and a polyalcohol, an emulgator and water. The treatment was carried out at underpressure for 15-30 minutes followed overpressure for 90 minutes-4 hours, optionally followed by underpressure for 15 minutes. At the end of the treatment, the excess liquid was removed and the wood was dried.

U.S. Pat. No. 2,382,374 is directed to a wood impregnation method. The impregnation involves the use of elevated pressure followed by heating the impregnation bath at atmospheric pressure. The impregnation liquid used is an organic wood preservative.

WO2015095900 is directed to a wood impregnation method wherein the wood is initially treated at temperatures up to 230° C. and then subjected to pressure impregnation with a wax-based composition.

There is thus a need for an improved modified wood product, in particular a thermally modified wood product that is less susceptible to weathering. There is also a need for improved processes for preparing such modified wood products.

### SUMMARY OF THE INVENTION

It is an object of the present invention to provide a wood product having improved weathering properties, improved water repellency and a visually even surface quality.

Another object of the present invention is to provide a process for producing said modified wood in an efficient way.

These objects and other advantages are achieved by the process and the product according to the independent claims.

Thus, the present invention relates to a process for preparing a modified wood product, comprising the steps of
a) impregnating wood with an impregnation liquid comprising water-based wood oils in an impregnation vessel at elevated pressure of up to 13 bar for at least 1 minute; followed by
b) stabilizing the impregnated wood by maintaining the impregnated wood in the impregnation liquid in the impregnation vessel at atmospheric pressure for at least 60 minutes.

In one embodiment of the invention, the wood to be impregnated has been thermally modified prior to the impregnation. During the thermal modification step, the wood is heated at a temperature of from 160° C. to 230° C. at atmospheric pressure or at a temperature of from 120° C. to 230° C. at a pressure higher than atmospheric pressure. Such thermally modified wood is generally referred to as ThermoWood.

The present invention also relates to wood treated according to the process described above. In one embodiment of the present invention, the treated wood is softwood. In one embodiment of the present invention, the treated wood is hardwood.

### DETAILED DESCRIPTION

The invention relates to a process for preparing modified wood wherein the wood is impregnated.

In one embodiment of the present invention, the wood modified according to the present invention has its final product profile, i.e. it is planed and profiled, when being impregnated according to the present process.

In one embodiment of the present invention, vacuum or a reduced pressure is applied prior to step a). The vacuum or reduced pressure is typically applied during less than 10 minutes, such as during 1 second to 10 minutes, such as during 2 minutes to 5 minutes.

In one embodiment of the invention, step a) is carried out at a temperature of about 15-30° C., such as at or about room temperature or ambient temperature, i.e. without applying any heating.

In one embodiment of the invention, the duration of step a) is in the range of from 1 minute to 2 hours, such as from 1 minute to 60 minutes or from 1 minute to 30 minutes.

In one embodiment of the invention, the pressure used in step a) is from 3 to 13 bar, such as from 5 to 10 bar, such as from 7 to 8 bar. In one embodiment, the pressure is released rapidly by the end of step a). The pressure may be released during a time period of less than 5 minutes, such as during a time period of less than 1 minute.

In one embodiment of the invention, the impregnation liquid is normally an aqueous solution with a dry matter content from 1% to 50%. In one embodiment of the present invention, the dry matter content of the impregnation liquid is from 10% to 15%. The pH of the impregnation liquid is generally in the range of from pH 7 to pH 9. The impregnation liquid may optionally contain additional components such as pigments. Water-based wood oils suitable for use in accordance with the present invention are commercially available.

In one embodiment of the invention, the duration of step b) is from 60 minutes to 4 hours, such as from 60 minutes to 3 hours or from 60 minutes to 2 hours.

In one embodiment of the invention, step b) is carried out at a temperature of about 15-30° C., such as at or about room temperature or ambient temperature, i.e. without applying any heating.

The moisture content of the wood used in the process according to the present invention is typically less than 16%, such as less than 8%, or from 4% to 7%. The moisture content of wood can be determined using methods known in the art.

In one embodiment of the invention, the wood to be used in the process according to the present invention has been thermally modified prior to being used in the process. The thermal modification can be done in an essentially oxygen free environment. This can be an advantage if high temperatures are used since wood easily ignites at high temperatures but the absence of oxygen will eliminate that risk.

During the thermal modification, the wood is heated at a temperature of from 160° C. to 230° C. at atmospheric pressure or at a temperature of from 120° C. to 230° C. at a pressure higher than atmospheric pressure. In one embodiment, the temperature is between 200° C. and 230° C. at atmospheric pressure.

The time required for the thermal modification step depends on the wood used, but is generally in the range of from 30 seconds to 5 hours, such as about 1 hour to 2 hours. The process parameters chosen for the thermal modification of the wood depends on the wood used and on the end use of the final wood product.

In one embodiment, a temperature gradient is used during the thermal modification step. In this embodiment, the wood is first heated to a consistent temperature throughout the cross section of the wood pieces, followed by a rapid cooling to create a temperature gradient whereby the core of the wood has a higher temperature than the surface.

It has surprisingly been found that the process according to the present invention, which includes a stabilization step (step b) of the process according to the present invention), enables the water-based wood oils to attach to the wood, resulting in relatively even surface appearance with respect to the colour, especially when using coloured wood oils. This has been noted particularly with thermally modified wood which has a surface that is more hydrophobic than normal wood, and several other properties which affect the required process parameters.

After step b), the impregnation liquid is removed from the impregnation vessel and the modified wood is taken out of the impregnation vessel.

The present invention also relates to wood treated according to the process described above. The wood produced will have higher resistance against the deteriorating weather effects. The improved water repellency results in better dimensional and shape stability, and consequently, in smaller tendency of checking in use. When using pigmented wood oils in impregnation, the UV protection of wood is improved which results in better colour stability, and may prolong the maintenance interval of the product. It is preferred that the treated wood is softwood. However, it is also possible to treat other kind of wood with the process according to the invention, such as hardwood.

The produced modified wood product can be used for the production of many different products, such as cladding, decking, window and door profiles, light poles, jetties, joinery, furniture etc.

### EXAMPLES

### Example 1

Artificial weathering test was carried out following the standard ISO 16474. The test comprised of two recurring cycles. The length of the first cycle was 18 minutes and that of the second cycle 102 minutes. The cycles were repeated until achieving the total test time of 1,200 hours. In the first cycle the samples were exposed to the UV light and water spray, whereas in the second cycle the samples were exposed to the UV light only. The other test parameters were kept constant throughout the test: the black panel temperature was 55° C., chamber temperature 38C° , relative humidity in the chamber 50%, irradiance at 340 nm 0.51 W/(m^{2·} nm), and the filter system the Daylight.

The artificial weathering test was done simultaneously for a sample of standard ThermoWood (Thermo-D) specimens with no surface coating or other protective treatment, and for a sample of ThermoWood (Thermo-D) specimens impregnated with water-based wood oil which contained brown pigment. The impregnation process parameters were as follows: the initial vacuum of 0.25 bars, the maximum pressure 8 bars, and the total process time 195 minutes including the stabilization phase of minimum 60 minutes at the atmospheric pressure, at room temperature.

All test materials had been planed and profiled similarly before the oil impregnation and the weathering test. The standard ThermoWood was considered as the reference sample in the test.

Colour measurement of each specimen was done at 200 hours' intervals during the weathering test. The measurement was carried out with SP60 Portable Sphere Spectrophotometer.

The colour parameters were measured at the same measurement points on the weathered surfaces of the specimens. The measurement was based on the method of the Commission International de l'Eclairage (CIE) using colour parameters, L*, lightness, a*, along the X axis red to green, and b* along the Y axis yellow to blue. The colour coordinate changes (ΔL*, Δa* and Δb*) were calculated using the measured colour parameter values in the end and in the beginning of the test. To total colour change ≢E*_{ab} of the samples was calculated as follows:

ΔE*_{ab}=\sqrt{(L*₂−L*₁)²+(a*₂−a*₁)²+(b*₂−b*₁)²} (Eq. 1)

TABLE 1
The colour differences of ThermoWood and oil-treated ThermoWood
samples over the 1,200 hours' weathering test.

Colour coordinate changes

| Quality of wood | ΔL* | Δa* | Δb* | ΔE* |
|---|---|---|---|---|
| ThermoWood | 22.6 | −6.2 | −15.8 | 28.2 |
| ThermoWood treated | −7.6 | −2.1 | −2.3 | 8.2 |
| with wood oil | | | | |

The artificial weathering test results (Table 1) indicated that the lightness (L*) of standard ThermoWood changed towards white and that of the oil-treated ThermoWood towards black during the test. In both samples a minor change in the colour coordinate a* was noted, indicating a decrease in the redness of the samples. The change in the colour coordinate b* was towards blue in the both samples, the change being larger for ThermoWood reference than for the oil-treated ThermoWood. The overall colour change value ΔE* was markedly larger for standard ThermoWood than for the ThermoWood impregnated with pigmented wood oil. Thus it may be concluded that the wood-oil treatment protects the surface of wood from weathering, slowing down the effects of UV radiation and moisture changes, especially when pigmented wood oils are used. Based on the test results, the wood-oil retention achieved with the impregnation method described in the present invention is effective against the weathering of wood when tested according to the described test details. The improved weathering performance may result in extended maintenance intervals of the products.

In view of the above detailed description of the present invention, other modifications and variations will become apparent to those skilled in the art. However, it should be apparent that such other modifications and variations may be effected without departing from the spirit and scope of the invention.

1. A process for preparing a modified wood product, comprising the steps of,
a) impregnating wood with an impregnation liquid comprising water-based wood oils in an impregnation vessel at elevated pressure of up to 13 bar for at least 1 minute; followed by
b) stabilizing the impregnated wood by maintaining the impregnated wood in the impregnation liquid in the impregnation vessel at atmospheric pressure for at least 60 minutes.

2. The process according to claim 1, wherein the wood has been thermally modified prior to step a).

3. The process according to claim 2, wherein the wood has been thermally modified by heating the wood at a temperature of from 160° C. to 230° C. at atmospheric pressure or at a temperature of from 120° C. to 230° C. at a pressure higher than atmospheric pressure.

4. The process according to claim 1, wherein the wood is softwood.

5. The process according to claim 1, wherein a moisture content of the wood prior to step a) is from 4% to 7%.

6. The process according to claim 1, wherein a temperature of step a) is from 15° C. to 30° C.

7. The process according to claim 1, wherein a temperature of step b) is from 15° C. to 30° C.

8. The process according to claim 1, wherein the elevated pressure in step a) is in a range from 5 to 10 bar.

9. A modified wood product obtained by a process according to claim 1.
